(19) United States
(12) Patent Application Publication
(10) Pub. No.: US 2022/0088903 A1
(43) Pub. Date: Mar. 24, 2022

(54) THREE-DIMENSIONAL COLD FORMED CURVED COMPOSITES

(71) Applicant: Corning Incorporated, Corning, NY (US)

(72) Inventors: Jeffrey Lynn Cole, Pine City, NY (US); Arpita Mitra, Columbus, OH (US); Matthew Carl Morse, Horseheads, NY (US); Michael David Shorkey, Corning, NY (US)

(21) Appl. No.: 17/419,972

(22) PCT Filed: Jan. 2, 2020
(86) PCT No.: PCT/US2020/012045

§ 371 Date: Jun. 30, 2021

Related U.S. Application Data
(60) Provisional application No. 62/788,292, filed on Jan. 4, 2019.

(51) Int. Cl. B32B 17/06; B32B 17/10; B32B 7/12; B32B 3/02; B32B 7/022; B32B 3/26; B32B 27/20

(52) U.S. Cl. CPC B32B 17/061; B32B 2319/00; B32B 7/12; B32B 3/02; B32B 7/022; B32B 3/26; B32B 27/20; B32B 2307/54; B32B 2307/732; B32B 2311/24; B32B 2307/542; B32B 2605/003; B32B 2250/02; B32B 2369/00; B32B 2323/16; B32B 2323/10; B32B 17/10

(57) ABSTRACT

The disclosure relates to composites comprising: a cold-formed decorated or non-decorated glass substrate having first and second major surfaces; a metal or polymeric substrate having first and second major surface; and at least one adhesive located between the glass substrate first major surface and the metal or polymeric substrate first major surface; the glass substrate first and second major surfaces and the metal or polymeric substrate first and second major surfaces defining at least one curvature, the at least one curvature having a bend radius of about 60 mm or greater; wherein the composite maintains adhesion between the glass substrate and the metal or polymeric substrate following physical testing according to a modified GMW3172 environmental and durability test.

### CROSS-REFERENCE TO RELATED APPLICATIONS

This application claims the benefit of priority under 35 U.S.C. § 119 of U.S. Provisional Application Ser. No. 62/788,292 filed on Jan. 4, 2019 the content of which is relied upon and incorporated herein by reference in its entirety.

### BACKGROUND

Vehicle interiors can include curved surfaces that incorporate displays and/or touch panel. The materials used to form such curved surfaces are typically limited to polymers, which do not exhibit the durability and optical performance of glass. As such, curved glass substrates are desirable, especially when used as covers for displays and/or touch panels. Existing methods of forming curved glass substrates, such as thermal forming, have drawbacks including high cost, and optical distortion and/or surface marking occurring during curving or shaping. Accordingly, there is a need for vehicle interior systems that can incorporate a curved glass substrate in a cost-effective manner and without the problems typically associated with glass thermal forming processes. Further, there is a need for adhesives that maintain adequate bonding of curved glass substrates to surfaces in a vehicle interior, including in areas having tight bend radii, such that the bonded curved glass substrates will have instantaneous survivability and reliability substantially over the entire life of a vehicle.

### SUMMARY

The disclosure provides, among other things, composites, including laminates, that maintain adhesion between a cold-formed decorated or non-decorated glass substrate and a metal or polymeric substrate, (i) even where there is are tight bending radii in the composite; and (ii) even following physical testing according to a modified GMW3172 environmental and durability test. The disclosure describes adhesives that will meet both features, (i) and (ii).

### DESCRIPTION OF THE DRAWINGS

The drawings illustrate generally, by way of example, but not by way of limitation, various embodiments discussed herein.

FIG. 1 is a perspective view illustration of a vehicle interior with vehicle interior systems according to one or more embodiments.

FIG. 2 is a side view illustration of a display including a curved glass substrate with no flat tip.

FIG. 3 is a side view illustration of the glass substrate used in the display of FIG. 2.

FIG. 4 is a front perspective view illustration of the glass substrate of FIG. 3.

FIG. 5 is a side view illustration of a complexly curved cold-formed glass substrate having a distinct radius of curvature in two independent directions which may be the same or different radii from one another.

FIG. 6 is a chart showing various structural adhesives that are useful in the composites described herein.

FIG. 7 is a flow chart showing physical testing according to a modified GMW3172 environmental and durability test that is used to evaluate the composites described herein.

FIG. 8 is a table showing adhesives identified for cold formed 0.7 mm glass substrate products that passed cumulative stress testing according to the flow chart shown in FIG. 7 of: Leg 1: 85 C/85% RH+Humid Heat Cyclic with Frost+95° C./500 h+Vibration with Thermal cycling+Mechanical shock—Pothole; and leg 2: Thermal shock.

FIG. 9 is a table showing adhesives identified for cold formed 0.55 mm glass substrate products that passed cumulative stress testing according to the flow chart shown in FIG. 7 of: Leg 1: 85 C/85% RH+Humid Heat Cyclic with Frost+95° C./500 h+Vibration with Thermal cycling+Mechanical shock—Pothole; and leg 2: Thermal shock.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, “bottom”, “upper”, “lower”, “under”, “over”, “front”, “back”, “up” and “down”, and “first” and “second” may be used in this disclosure, it should be understood that those terms are used in their relative sense only unless otherwise noted.

### DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Cold forming (e.g., bending) is an energy efficient method of creating curved glass substrates based on the elastic deformation of glass at relatively low temperature (e.g., <140° C.) with the application of out of plane loads to create the desired shape. During the cold forming process, a flat high-strength glass is three-dimensionally (3D) deformed and mechanically fixed by an adhesive interlayer to a target pre-formed 3D frame (e.g., a metal, such as magnesium, aluminum, and alloys thereof, steel, and alloys thereof or a polymer/copolymer/polymer blend such as PC/ABS, PP/EPDM, PC/PBT alloys, PP, PC copolymer blends, all of which may be filled or unfilled, (glass or carbon fiber) reinforced or unreinforced, and the like). Lamination of the display functional module(s) may occur before or after the 3D cold forming process. This cold forming process results in stresses in the resulting curved glass substrates, the adhesive layer, and the target frame.

The produced mechanical stresses in the adhesive due to glass bending will last throughout its lifetime. The mechanical stresses can cause not only instantaneous failure of the adhesive, but also long-term reliability/durability issues. Desired stress thresholds of adhesives are some of the critical values to determine its instantaneous survivability and long-term reliability/durability. The thresholds are varied depending on adhesive types, bondline dimensions (e.g., the width and height of the bondline), glass mechanical properties, material type, geometry of the pre-formed 3D frame, and reliability/durability of the composites described herein.

The instant disclosure, therefore, provides a composite, including laminates, comprising: a cold-formed decorated or non-decorated glass substrate having first and second major surfaces; a metal or polymeric substrate having first and second major surface; and at least one adhesive located between the glass substrate second major surface and the metal or polymeric substrate first major surface; the glass substrate first and second major surfaces and the metal or polymeric substrate first and second major surfaces defining at least one curvature, the at least one curvature having a bend radius of about 60 mm or greater (e.g., from about 60 mm to about 10000 mm, about 60 mm to about 7500 mm, about 60 mm to about 50000 mm, about 60 mm to about 4000 mm, about 60 mm to about 3000 mm, about 60 mm to about 2000 mm, about 60 mm to about 1000 mm, about 60 mm to about 600 mm, about 60 mm to about 250 mm, about 100 mm to about 500 mm, about 300 mm to about 1000 mm, about 500 mm to about 750 mm, about 250 mm to about 800 mm or about 100 mm to about 450 mm);

wherein the composite maintains adhesion between the glass substrate and the metal or polymeric substrate following physical testing according to a modified GMW3172 environmental and durability test.

Suitable glass substrates for use herein include, but are not limited to, soda lime glass, aluminosilicate glass, borosilicate glass, boroaluminosilicate glass, alkali-containing aluminosilicate glass, alkali-containing borosilicate glass, alkali-containing boroaluminosilicate glass, polycarbonate, polyimide, and acrylates/acrylics, such as polymethyl methacrylate.

The glass substrate, frame, and the adhesive that bonds the glass substrate to the frame can be found in a vehicle interior system. The vehicle interior system, in turn, can be incorporated into any vehicle, including trains, automobiles (e.g., cars, trucks, buses and the like), seacraft (boats, ships, submarines, and the like), and aircraft (e.g., drones, airplanes, jets, helicopters and the like).

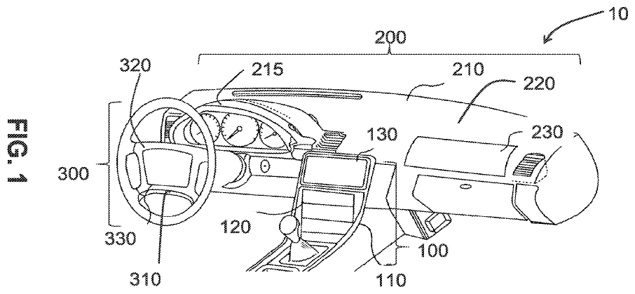

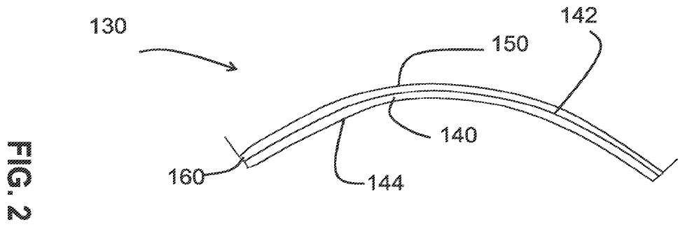

FIG. 1 provides an example of a vehicle interior 10, including vehicle interior systems 100, 200, 300. Vehicle interior system 100 includes a center console base 110 with a curved surface 120 including a display 130. Vehicle interior system 200 includes a dashboard base 210 with a curved surface 220 including a display 230. The dashboard base 210 typically includes an instrument panel 215 which may also include a display. Vehicle interior system 300 includes a dashboard steering wheel base 310 with a curved surface 320 and a display 330. The vehicle interior system can include a base that is an arm rest, a pillar, a seat back, a floor board, a headrest, a door panel, or any portion of the interior of a vehicle that includes a curved surface.

The glass substrate described herein can be used as curved cover glass for any of the display described herein, including for use in vehicle interior systems 100, 200 and/or 300. As used herein, the term “glass substrate” is used in its broadest sense to include any object made wholly or partly of glass. Glass substrates include laminates of glass and non-glass materials, laminates of glass and crystalline materials, and glass-ceramics (including an amorphous phase and a crystalline phase). The glass substrate can be transparent or opaque. The glass substrate can include a colorant that provides a specific color. In addition, the glass substrate can be decorated or non-decorated. When decorated, the glass substrate can be decorated with a coating on one or two sides with a coating, such as an ink coating (e.g., polyurethane or acrylic inks) or an antireflective coating.

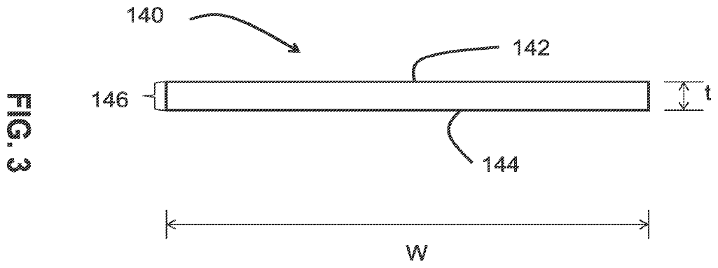

As shown in FIG. 2, the display 130 includes cold-formed curved glass substrate 140 having a first radius of curvature and a frame 150, and an adhesive layer 160 located between the glass substrate 140 and the frame 150, wherein at least a portion of the frame 150 has a second radius of curvature that approximates or matches the first radius of curvature, to provide a display 130 with a curved glass substrate as a cover glass that can be integrated into a curved surface of a vehicle interior system. Convex or concave displays, as well as displays having both convex and concave features, are contemplated herein.

Frame 150 can be made of any suitable material, including from a metal such as stainless steel, and alloys thereof; aluminum, and alloys thereof; and magnesium and alloys thereof. In some instances, at least one of the frame 150 and the cold-formed curved glass substrate 140 comprises a surface modification such as those that result from surface modification resulting from grit blasting or other surface roughening; galvanizing; e-coating; acid etching; priming; painting; and the like.

Stainless steels can vary in composition from a simple alloy of iron and chromium to complex alloys containing chromium, nickel, and various other elements in small quantities.

There are three main classifications of stainless steels distinguished based on their composition and internal structure. These types are austenitic, ferritic, and martensitic.

Austenitic steels are alloys containing 16-26% chromium and 6-22% nickel. They are non-magnetic and have excellent corrosion resistance. They are not hardenable by heat treatment. However, they can develop high strength even from light cold working. They are identified in the AISI 300 series.

Ferritic steels are alloys that contain 12-30% chromium without nickel. They are ferro-magnetic in nature and possess good resistance to corrosion and fair weldability. They are identified in the AISI 400 series.

Martensitic steels are alloys that contain 11-14% Chromium without nickel but with a slightly higher carbon content compared to the austenitic and ferritic stainless steels. They are ferro-magnetic in nature and hardenable by heat treatment. They have moderate corrosion resistance, poor weldability, and are identified in the AISI 400 series.

Steels can be separated based on specific grades or types. Some of the most common are type 304, type 316, type 410, and type 430. Type 304 is the most commonly produced stainless steel, accounting for more than half of all stainless steel production. It is an austenitic grade that withstands ordinary. Type 316 is austenitic steel containing molybdenum, giving it greater resistance to various types of deterioration and corrosion. Type 410 is the most widely used martensitic stainless steel. It is high strength, low-cost, and heat-treatable and is suited for non-severe corrosion applications. Type 430 is the most widely used ferritic stainless steel, offering standard corrosion resistance.

Aluminum alloys can be categorized into a number of groups based on the particular material's characteristics such as its ability to respond to thermal and mechanical treatment and the primary alloying element added to the aluminum alloy. Wrought and cast aluminums have different systems of identification. The wrought system is a 4-digit system and the castings having a 3-digit and 1-decimal place system. In some embodiments, wrought aluminum alloys are contemplated, including the 1000-, 2000-, 3000-, 4000-, 5000-, 6000-, and 7000-series of wrought aluminum alloys which can be categorized as shown in Table 1, where: x, if different from 0, indicates a modification of the specific alloy, and y and z are arbitrary numbers given to identify a specific alloy in the series. For example, 5000-series alloy 5183, the number 5 indicates that it is of the magnesium alloy series, the 1 indicates that it is the 1st modification to the original alloy 5083, and the 83 identifies it in the 5xyz series. The only exception to this alloy numbering system is with the 1xyz series aluminum alloys (pure aluminums) in which case, y and z provide the minimum aluminum percentage above 99%. Thus, for example, 1000-series alloy 1350 comprises 99.50% minimum aluminum.

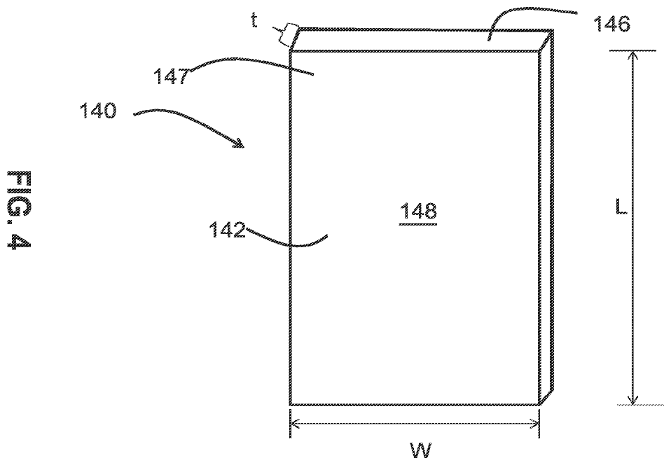

Making reference to FIGS. 3 and 4, the cold-formed glass substrate 140 includes a first major surface 142 and a second major surface 144 opposite the first major surface. The cold-formed glass substrate exhibits the first radius of curvature as measured on the second major surface 144.

As used herein, the terms “cold-formed,” “cold-bent,” “cold-bending,” “cold-forming” or “cold forming” refers to curving the glass substrate at a cold-forming temperature which is less than the softening point of the glass. The term “cold-bendable” refers to the capability of a glass substrate to be cold-bent. A feature of a cold-formed glass substrate is asymmetric surface compressive stress between the first major surface 142 and the second major surface 144. A minor surface 146 connects the first major surface 142 and the second major surface 144. Prior to the cold-forming process or being cold-formed, the respective compressive stresses in the first major surface 142 and the second major surface 144 of the glass substrate are substantially equal. When the glass substrate is unstrengthened, the first major surface 142 and the second major surface 144 exhibit no appreciable compressive stress, prior to cold-forming. When the glass substrate is strengthened, the first major surface 142 and the second major surface 144 exhibit substantially equal compressive stress with respect to one another, prior to cold-forming.

The glass substrate can be strengthened using any suitable method known in the art, including by including compressive stress (CS) into the glass substrate, that extends from a surface to a depth of compression (DOC); by utilizing a mismatch of the coefficient of thermal expansion between portions of the composite to create a compressive stress region and a central region exhibiting a tensile stress; thermally by heating the glass to a temperature above the glass transition point and then rapidly quenching; and chemically by ion exchange, where, e.g., ions at or near the surface of the glass substrate are replaced by, or exchanged with, larger ions having the same valence or oxidation state.

The thickness of the glass substrate can be tailored to allow the glass substrate to be more flexible to achieve the desired radius of curvature. Moreover, a thinner glass substrate 140 may deform more readily, which could potentially compensate for shape mismatches and gaps that may be created by the shape of the display module 150 (when curved). In one or more embodiments, a thin and strengthened glass substrate 140 exhibits greater flexibility especially during cold-bending. The greater flexibility of the glass substrates discussed herein may both allow for sufficient degrees of bending to be created via the air pressure-based bending processes as discussed herein and also for consistent bend formation without heating. The glass substrate 140 and at least a portion of the display module 150 have substantially similar radii of curvature to provide a substantially uniform distance between the first major surface 142 and the display module 150, which can be filled with an adhesive.

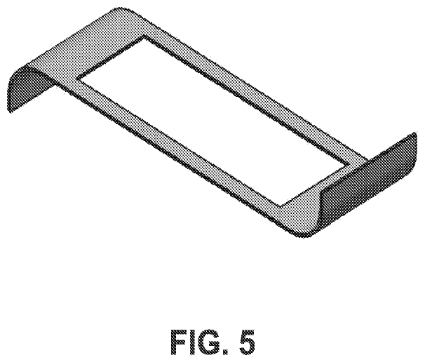

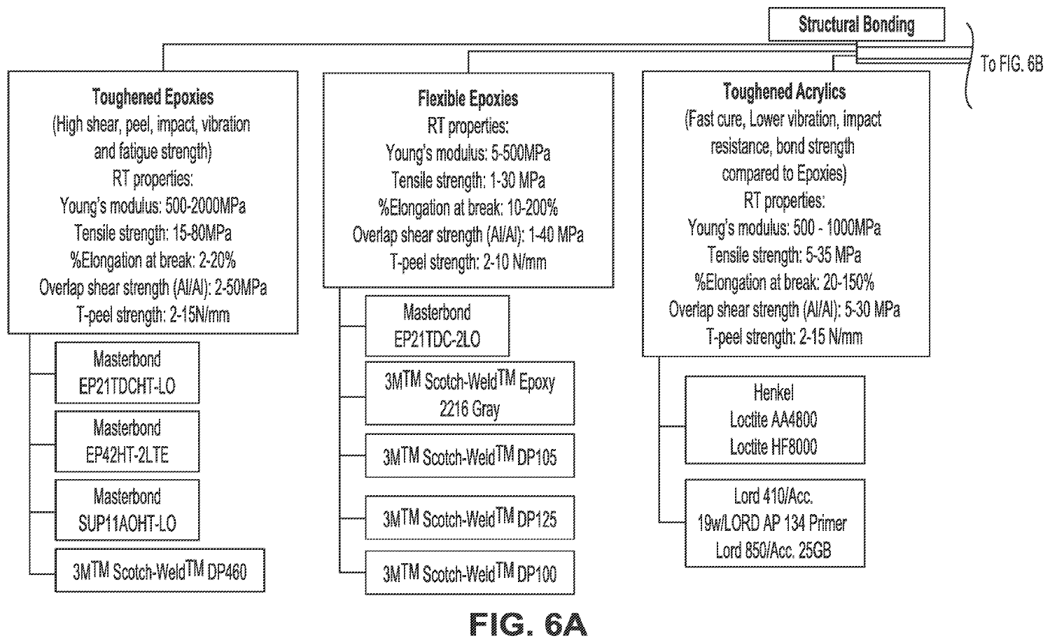

The cold-formed glass substrate (and optionally a curved display module) can have a compound curve including a major radius and a cross curvature. Complexly curved cold-formed glass substrates include substrates having a C-shape, a J-shape, an S-shape, a V-shape, and windshields. A complexly curved cold-formed glass substrate (and optionally the curved display module) can have a distinct radius of curvature in at least two different regions of the substrate (e.g., as in a windshield) or in at least two independent directions, which may be the same or different radii from one another, as shown in FIG. 5. The complexly curved cold-formed glass substrate (and optionally the curved display module) can thus be characterized as having “cross curvature,” where the cold-formed glass substrate (and optionally a curved display module) are curved along an axis (e.g., a first axis) that is parallel to a given dimension and also curved along an axis (e.g., a second axis) that is perpendicular to the same dimension. The curvature of the cold-formed glass substrate (and optionally the curved display module) can be even more complex when a significant minimum radius is combined with a significant cross curvature, and/or depth of bend.

The cold-formed glass substrate has a thickness (t) that is substantially constant and is defined as a distance between the first major surface 142 and the second major surface 144. The thickness (t) as used herein refers to the maximum thickness of the glass substrate. As shown in FIGS. 3-4, the glass substrate includes a width (W) defined as a first maximum dimension of one of the first or second major surfaces orthogonal to the thickness (t), and a length (L) defined as a second maximum dimension of one of the first or second surfaces orthogonal to both the thickness and the width. The dimensions discussed herein can be average dimensions.

The glass substrate can have a bending radius, or radius of curvature. The radius of curvature can be, for example, about 20 mm or greater, 40 mm or greater, 50 mm or greater, 60 mm or greater, 100 mm or greater, 250 mm or greater or 500 mm or greater. For example, the first radius of curvature can be in a range from about 60 mm to about 1200 mm, about 20 mm to about 10000 mm, from about 30 mm to about 10000 mm, from about 40 mm to about 10000 mm, from about 50 mm to about 10000 mm, 60 mm to about 10000 mm, from about 70 mm to about 10000 mm, from about 80 mm to about 10000 mm, from about 90 mm to about 10000 mm, from about 100 mm to about 10000 mm, from about 120 mm to about 10000 mm, from about 140 mm to about 10000 mm, from about 150 mm to about 10000 mm, from about 160 mm to about 10000 mm, from about 180 mm to about 10000 mm, from about 200 mm to about 10000 mm, from about 220 mm to about 10000 mm, from about 240 mm to about 10000 mm, from about 250 mm to about 10000 mm, from about 260 mm to about 10000 mm, from about 270 mm to about 10000 mm, from about 280 mm to about 10000 mm, from about 290 mm to about 10000 mm, from about 300 mm to about 10000 mm, from about 350 mm to about 10000 mm, from about 400 mm to about 10000 mm, from about 450 mm to about 10000 mm, from about 500 mm to about 10000 mm, from about 550 mm to about 10000 mm, from about 600 mm to about 10000 mm, from about 650 mm to about 10000 mm, from about 700 mm to about 10000 mm, from about 750 mm to about 10000 mm, from about 800 mm to about 10000 mm, from about 900 mm to about 10000 mm, from about 950 mm to about 10000 mm, from about 1000 mm to about 10000 mm, from about 1250 mm to about 10000 mm, from about 1500 mm to about 10000 mm, from about 1750 mm to about 10000 mm, from about 2000 mm to about 10000 mm, from about 2250 mm to about 10000 mm, from about 2500 mm to about 10000 mm, from about 2750 mm to about 10000 mm, from about 3000 mm to about 10000 mm, from about 5000 mm to about 10000 mm, from about 20 mm to about 9000 mm, from about 20 mm to about 8000 mm, from about 20 mm to about 7000 mm, from about 20 mm to about 6000 mm, from about 20 mm to about 5000 mm, from about 20 mm to about 4500 mm, from about 20 mm to about 4000 mm, from about 20 mm to about 3500 mm, from about 20 mm to about 3000 mm, from about 20 mm to about 2750 mm, from about 20 mm to about 2500 mm, from about 20 mm to about 2250 mm, from about 20 mm to about 2000 mm, from about 20 mm to about 1900 mm, from about 20 mm to about 1800 mm, from about 20 mm to about 1700 mm, from about 20 mm to about 1600 mm, from about 20 mm to about 1500 mm, from about 20 mm to about 1400 mm, from about 20 mm to about 1300 mm, from about 20 mm to about 1200 mm, from about 20 mm to about 1100 mm, from about 20 mm to about 1000 mm, from about 20 mm to about 950 mm, from about 20 mm to about 900 mm, from about 20 mm to about 850 mm, from about 20 mm to about 800 mm, from about 20 mm to about 750 mm, from about 20 mm to about 700 mm, from about 20 mm to about 650 mm, from about 20 mm to about 200 mm, from about 20 mm to about 550 mm, from about 20 mm to about 500 mm, from about 20 mm to about 450 mm, from about 20 mm to about 400 mm, from about 20 mm to about 350 mm, from about 20 mm to about 300 mm, from about 20 mm to about 250 mm, from about 20 mm to about 200 mm, from about 20 mm to about 150 mm, from about 20 mm to about 100 mm, from about 20 mm to about 50 mm, from about 150 mm to about 5000 mm, from about 200 mm to about 5000 mm, from about 250 mm to about 5000 mm, from about 300 mm to about 5000 mm, from about 350 mm to about 5000 mm, from about 400 mm to about 5000 mm, from about 450 mm to about 5000 mm, from about 500 mm to about 5000 mm, from about 550 mm to about 5000 mm, from about 600 mm to about 5000 mm, from about 650 mm to about 5000 mm, from about 700 mm to about 5000 mm, from about 750 mm to about 5000 mm, from about 800 mm to about 5000 mm, from about 850 mm to about 5000 mm, from about 900 mm to about 5000 mm, from about 950 mm to about 5000 mm, from about 1000 mm to about 5000 mm, from about 150 mm to about 4500 mm, from about 150 mm to about 4000 mm, from about 150 mm to about 3500 mm, from about 150 mm to about 3000 mm, from about 150 mm to about 2750 mm, from about 150 mm to about 2500 mm, from about 150 mm to about 2250 mm, from about 150 mm to about 2000 mm, from about 150 mm to about 1750 mm, from about 150 mm to about 1500 mm, from about 150 mm to about 1250 mm, from about 150 mm to about 1000 mm, from about 250 mm to about 2000 mm, from about 250 mm to about 1000 mm, from about 60 mm to about 1400 mm, from about 60 mm to about 1300 mm, from about 60 mm to about 1200 mm, from about 60 mm to about 1100 mm, from about 60 mm to about 1000 mm, from about 60 mm to about 950 mm, from about 60 mm to about 900 mm, from about 60 mm to about 850 mm, from about 60 mm to about 800 mm, from about 60 mm to about 750 mm, from about 60 mm to about 700 mm, from about 60 mm to about 650 mm, from about 60 mm to about 600 mm, from about 60 mm to about 550 mm, from about 60 mm to about 500 mm, from about 60 mm to about 450 mm, from about 60 mm to about 400 mm, from about 60 mm to about 350 mm, from about 60 mm to about 300 mm, or from about 60 mm to about 250 mm. In one or more embodiments, glass substrates having a thickness of less than about 0.4 mm may exhibit a radius of curvature that is less than about 100 mm, or less than about 60 mm.

The glass substrate can have any suitable thickness, measured from the first major surface to the second major surface, at a glass substrate thickest portion, of about 0.2 mm to about 3 mm (e.g., about 0.2 mm to about 2 mm and about 0.4 mm to about 1.1 mm). For example, the glass substrate can have a thickness (t) that is about 1.5 mm or less. For example, the thickness can be in a range from about 0.01 mm to about 1.5 mm, about 0.02 mm to about 1.5 mm, 0.03 mm to about 1.5 mm, 0.04 mm to about 1.5 mm, 0.05 mm to about 1.5 mm, 0.06 mm to about 1.5 mm, 0.07 mm to about 1.5 mm, 0.08 mm to about 1.5 mm, 0.09 mm to about 1.5 mm, 0.1 mm to about 1.5 mm, from about 0.15 mm to about 1.5 mm, from about 0.2 mm to about 1.5 mm, from about 0.25 mm to about 1.5 mm, from about 0.3 mm to about 1.5 mm, from about 0.35 mm to about 1.5 mm, from about 0.4 mm to about 1 mm, from about 0.4 mm to about 1.5 mm, from about 0.45 mm to about 1.5 mm, from about 0.5 mm to about 1.5 mm, from about 0.55 mm to about 1.5 mm, from about 0.6 mm to about 1.5 mm, from about 0.65 mm to about 1.5 mm, from about 0.7 mm to about 1.5 mm, from about 0.01 mm to about 1.4 mm, from about 0.01 mm to about 1.3 mm, from about 0.01 mm to about 1.2 mm, from about 0.01 mm to about 1.1 mm, from about 0.01 mm to about 1.05 mm, from about 0.01 mm to about 1 mm, from about 0.01 mm to about 0.95 mm, from about 0.01 mm to about 0.9 mm, from about 0.01 mm to about 0.85 mm, from about 0.01 mm to about 0.8 mm, from about 0.01 mm to about 0.75 mm, from about 0.01 mm to about 0.7 mm, from about 0.01 mm to about 0.65 mm, from about 0.01 mm to about 0.6 mm, from about 0.01 mm to about 0.55 mm, from about 0.01 mm to about 0.5 mm, from about 0.01 mm to about 0.4 mm, from about 0.01 mm to about 0.3 mm, from about 0.01 mm to about 0.2 mm, from about 0.01 mm to about 0.1 mm, from about 0.04 mm to about 0.07 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, or from about 0.3 mm to about 0.7 mm.

The glass substrate can also have a width (W) in a range from about 5 cm to about 250 cm, from about 5 cm to about 20 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm.

The glass substrate can also have a length (L) in a range from about 5 cm to about 250 cm, from about 30 cm to about 90 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm.

The metal or polymeric substrate can have any suitable thickness. For example, the metal or polymeric substrate thickness can be in a range from about 0.5 mm to about 20 mm (e.g., from about 2 mm to about 20 mm, from about 3 mm to about 20 mm, from about 4 mm to about 20 mm, from about 5 mm to about 20 mm, from about 6 mm to about 20 mm, from about 7 mm to about 20 mm, from about 8 mm to about 20 mm, from about 9 mm to about 20 mm, from about 10 mm to about 20 mm, from about 12 mm to about 20 mm, from about 14 mm to about 20 mm, from about 1 mm to about 18 mm, from about 1 mm to about 16 mm, from about 1 mm to about 15 mm, from about 1 mm to about 14 mm, from about 1 mm to about 12 mm, from about 1 mm to about 10 mm, from about 1 mm to about 8 mm, from about 1 mm to about 6 mm, from about 1 mm to about 5 mm, from about 1 mm to about 4 mm, from about 1 mm to about 3 mm, from about 1 mm to about 2 mm, and all ranges and sub-ranges therebetween.

The adhesive can have any suitable bondline, which is defined by at least one of the adhesive's thickness and bezel width. Accordingly, as shown in FIG. 1, the adhesive can have any suitable thickness, measured from a surface of the adhesive that contacts the decorated or non-decorated glass substrate to a surface of the metal or polymeric substrate, wherein both substrates may or may not have a surface coating or texturing, for example, such as using a primer system, etching, surface roughening or e-coating. The thickness of the adhesive can be tailored to, among other things, ensure lamination between the metal or polymeric substrate and the glass substrate. For example, the adhesive can have a thickness of about 5 mm or less. The adhesive can have a thickness in a range from about 200 μm to about 500 μm, from about 225 μm to about 500 μm, from about 250 μm to about 500 μm, from about 275 μm to about 500 μm, from about 300 μm to about 500 μm, from about 325 μm to about 500 μm, from about 350 μm to about 500 μm, from about 375 μm to about 500 μm, from about 400 μm to about 500 μm, from about 200 μm to about 475 μm, from about 200 μm to about 450 μm, from about 200 μm to about 425 μm, from about 200 μm to about 400 μm, from about 200 μm to about 375 μm, from about 200 μm to about 350 μm, from about 200 μm to about 325 μm, from about 200 μm to about 300 μm, or from about 225 μm to about 275 μm.

The adhesive can also have any suitable bezel width. For example, can have a bezel width of about 50 mm or less, such as 25 mm or less. The adhesive can have a bezel width in a range from about 1 mm to about 15 mm, about 2 mm to about 50 mm, from about 5 mm to about 20 mm, from about 10 mm to about 15 mm, from about 1 mm to about 10 mm, from about 5 mm to about 10 mm, from about 5 mm to about 15 mm, from about 10 mm to about 20 mm, or from about 1 mm to about 5 mm.

Suitable adhesives include any adhesives showing, among other features, at least one of shrinkage upon cure of less than 5%; and low outgassing (e.g., less than about 5% loss by volume).

Suitable adhesives also include adhesives having at least one of an overlap shear strength of at least 0.5 MPa; tensile strength of at least 0.5 MPa; % elongation at break of at least 3%; and a peel T-peel strength of at least 2 N/mm at a temperature of from about 22° C. to about 25° C.

Suitable adhesives also include adhesives having at least one of ability to bond glass substrates and metal or polymeric substrates with linear coefficient of thermal expansion (CTE) ranging from (6-200)×10⁻⁶ m/(mK), high impact strength; Young's modulus of about 0.5 to about 5 GPa; tensile strength of about 15 MPa to about 80 MPa; % elongation at break of about 2% to about 20% to accommodate for, among other things, stresses due to differences in CTE and vibration, yet rigid enough to resist creep/sag; overlap shear strength of Al/Al of about 2 MPa to about 50 MPa; room temperature (RT; which is a temperature of from about 22° C. to about 25° C.) overlap shear strength of Al/polymeric substrate (e.g., an Al/polymeric substrate having decoration, primer, paint and the like) of about 2 MPa to about 40 MPa; and T-peel strength of about 2 N/mm to about 15 N/mm at a temperature of from about 22° C. to about 25° C. Adhesives having at least one of the foregoing properties are suitable for composites having at least one curve having a radius of curvature of about 250 mm or less. Such adhesives can have a glass transition temperature of from about 25° C. to about 100° C. and a storage modulus (E′) of from about 1 GPa to about 5 GPa at −40° C.; and from about 2 MPa to about 50 MPa at 95° C. Examples of adhesives having at least one of the foregoing properties include 2-part Toughened Epoxy (for example, Masterbond EP21TDCHT-LO, 3M Scotch Weld Epoxy DP460 Off-white).

Suitable adhesives also include adhesives having at least one of a Young's modulus of about 5 MPa to about 500 MPa; tensile strength of about 1 MPa to about 30 MPa; elongation at break of about 10% to about 200%; overlap shear strength (Al/Al) of about 1 MPa to about 40 MPa; and T-peel strength of about 2 N/mm to about 10 N/mm. Such adhesives can have a glass transition temperature from about 10° C. to about 50° C.; and storage modulus (E′) of from about 0.25 GPa to about 5 GPa at −40° C. and from about 0.5 MPa to about 40 MPa at 95° C. Examples of adhesives having at least one of the foregoing properties include Flexible Epoxy (for example, Masterbond EP21TDC-2LO, 3M Scotch Weld Epoxy 2216, 3M Scotch Weld Epoxy DP125, DP105, DP100+, Epoxy 2216 available from 3M®, Saint Paul, Minn. Adhesives having at least one of the foregoing properties are suitable for composites having at least one curve having a radius of curvature of about 150 mm or more (e.g., about 150 mm to about 3000 mm).

Other suitable adhesives also include adhesives having at least one of a Young's modulus of about 0.5 GPa to about 1 GPa; tensile strength of about 5 to about 35 MPa; elongation at break of about 20% to about 150%; overlap shear strength (Al/Al) of about 5 MPa to about 30 MPa; and T-peel strength of about 2 N/mm to about 15 N/mm. Such adhesives can have a glass transition temperature from about 25° C. to about 100° C.; and storage modulus (E′) of from about 0.5 GPa to about 2 GPa at −40° C. and from about 0.5 MPa to about 40 MPa at 95° C. Examples of adhesives having at least one of the foregoing properties include Toughened Acrylics (for example, LORD Adhesive 403, 406 or 410 Acrylic adhesives with LORD Accelerator 19 or 19 GB w/LORD AP 134 primer, LORD Adhesive 850 or 852/LORD Accelerator 25 GB, Loctite HF8000, Loctite AA4800). Adhesives having at least one of the foregoing properties are suitable for composites having at least one curve having a radius of curvature of about 150 mm or more (e.g., about 150 mm to about 3000 mm).

Other suitable adhesives also include adhesives having at least one of a Young's modulus of about 1 MPa to about 925 MPa; tensile strength of about 1 to about 40 MPa; elongation at break of about 40% to about 900%; overlap shear strength (Al/Al) of about 1 MPa to about 25 MPa. Such adhesives can have a glass transition temperature from about −70° C. to about 30° C.; and storage modulus (E′) of from about 10 MPa to about 5 GPa at −40° C. and from about 0.5 MPa to about 50 MPa at 95° C. Examples of adhesives having at least one of the foregoing properties include polyurethanes such as 3M Scotch Weld DP640, DP604NS, DP620NS available from 3M®, Saint Paul, Minn., Loctite HHD 3542, Betamate 73100/002, 73100/005, 73100/010, Betaseal X2500, and Betalink K2, from Dupont®, Wilmington, Del. Adhesives having at least one of the foregoing properties are suitable for composites having at least one curve having a radius of curvature of about 150 mm or more (e.g., about 150 mm to about 5000 mm).

Suitable adhesives also include adhesives having at least one of a tensile strength of about 1 MPa to about 10 MPa; % elongation at failure of about 50% to about 500%; overlap shear strength (Al/Al) of about 0.5 MPa to about 7 MPa. Adhesives having at least one of the foregoing properties are suitable for composites having at least one curve having a radius of curvature of about 150 mm or more (e.g., about 150 mm to about 5000 mm). Such adhesives can have a glass transition temperature of from about −70° C. to about −5° C. and a storage modulus (E′) of from about 5 MPa to about 400 MPa at −40° C.; and from about 0.5 MPa to about 5 MPa at 95° C. Examples of adhesives having at least one of the foregoing properties include silane modified polymers such as TEROSON RB IX, also known as TEROSTAT MS 9399, Teroson MS 930/Teroson MS 9371 and TEROSON MS 647, available from Loctite® and VIASeal XB.

Suitable adhesives also include adhesives having at least one of a tensile strength of about 0.5 MPa to about 5 MPa; % elongation at break of about 600% to about 1000%; overlap shear strength (Al/Al) of about 0.5 MPa to about 5 MPa. Adhesives having at least one of the foregoing properties are suitable for composites having at least one curve having a radius of curvature of about 400 mm or more (e.g., about 400 mm to about 5000 mm). Such adhesives can have a glass transition temperature of from about −50° C. to about −10° C. and a storage modulus (E′) of from about 10 MPa to about 50 MPa at −40° C.; and from about 0.25 MPa to about 5 MPa at 95° C. Examples of adhesives having at least one of the foregoing properties include silicones or siloxanes, such as Dow Corning 7091, 995 Silicone, Dow Corning HM-2600 Assembly sealant, Dow Corning HM-2500 Assembly sealant, 121 Structural Glazing Sealant as well as other organo-functional siloxanes. Adhesives having at least one of the foregoing properties are suitable for composites having at least one curve having a radius of curvature of about 250 mm or more (e.g., about 250 mm to about 5000 mm).

Suitable adhesives include polyurethanes (e.g., DP604NS available from 3M®, Saint Paul, Minn., as well as Betamate 73100/002, 73100/005, 73100/010, Betaseal X2500, and Betalink K2, from Dupont®, Wilmington, Del.), polysiloxanes and silane-modified polymers (e.g., TEROSON RB IX, also known as TEROSTAT MS 9399 and TEROSON MS 647, available from Loctite®), and epoxies (e.g., Scotch-Weld™ Epoxy Adhesive DP125 and DP105 available from 3M®, Saint Paul, Minn.).

Additional adhesives include, but not limited to, an adhesive selected from one of more of the categories: (a) Toughened Epoxy (for example, Masterbond EP21TDCHT-LO, 3M Scotch Weld Epoxy DP460 Off-white); (b) Flexible Epoxy (for example, Masterbond EP21TDC-2LO, 3M Scotch Weld Epoxy 2216); (c) Acrylics and/or Toughened Acrylics (for example, LORD Adhesive 403, 406 or 410 Acrylic adhesives with LORD Accelerator 19 or 19 GB w/LORD AP 134 primer, LORD Adhesive 850 or 852/LORD Accelerator 25 GB, Loctite HF8000, Loctite AA4800); (d) Polyurethanes (for example, 3M Scotch Weld Urethane DP640 Brown, SikaForce 7570 L03, SikaForce 7550 L15, Sikaflex 552 and Polyurethane (PUR) Hot Melt adhesives such as, Technomelt PUR 9622-02 UVNA, Loctite HHD 3542, Loctite HHD 3580, 3M Hotmelt adhesives 3764 and 3748); and (e) Silicones (Dow Corning 995, Dow Corning HM-2600 Silicone Assembly adhesive, Dow Corning 7091, SikaSil-GP). In some cases, structural adhesives available as sheets or films (for example, but not limited to, 3M Structural adhesive films AF126-2, AF 163-2M, SBT 9263 and 9214, Masterbond FLM36-LO) may be utilized. Furthermore, pressure sensitive adhesives such as 3M VHB tapes may be utilized. In such embodiments, utilizing a pressure sensitive adhesive allows for the curved glass substrate to be bonded to the frame without the need for, among other things, a curing step.

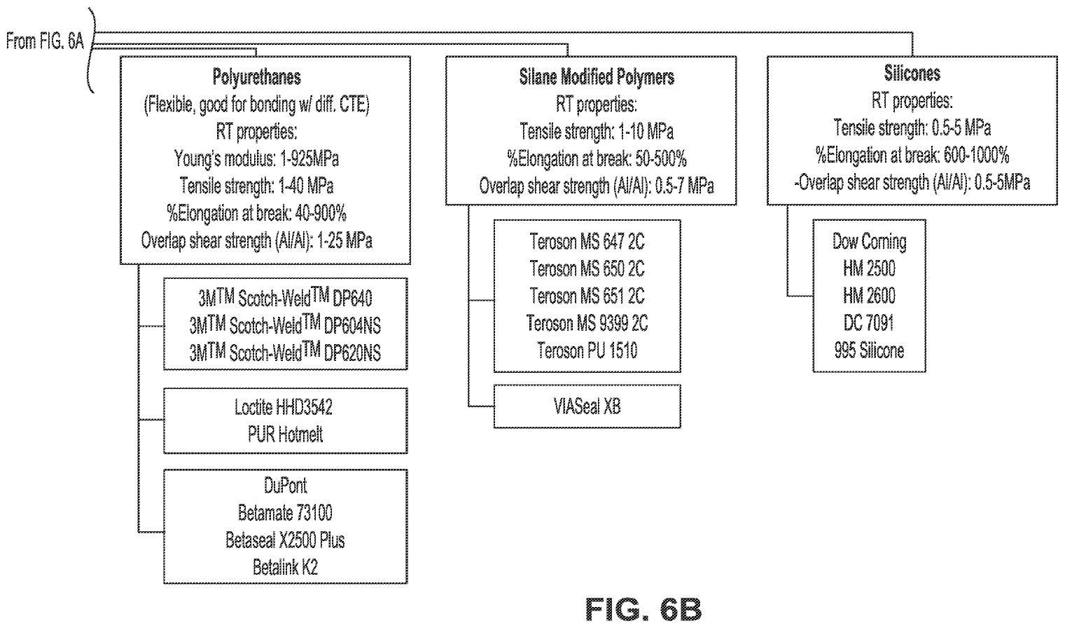

Examples of suitable adhesives, and their rhelogical properties are listed in Table 1 and their mechanical properties are shown in FIG. 6.

TABLE 1

| Adhesive | | Storage Modulus | | | | | | |
|---|---|---|---|---|---|---|---|---|
| Family | Adhesive | −40 C | | 23 C | | 95 C | | Tg (° C.) |
| Toughened | DP640 | 1.6 to 2.3 | GPa | 1.2 to 1.8 | GPa | 4.8 to 16.4 | MPa | 52-82 |
| Epoxy | EP21TDCHT- | 1.4 to 1.6 | GPa | 0.5 to 0.9 | GPa | 6.6 to 33 | MPa | 61-92 |
| | LO | | | | | | | |
| Flexible | Epoxy 2216 | 2.3 to 3.2 | GPa | 0.5 to 0.9 | GPa | 7.6 to 29.2 | MPa | 33 |
| Epoxy | DP125 | 1.5 to 2.7 | GPa | 0.02 to 0.5 | GPa | 1.9 to 10.8 | MPa | 23 to 33 |
| Polyurethane | DP640 | 1.8 to 2.5 | GPa | 7.25 to 88.3 | MPa | 5.5 to 17.2 | MPa | −4.5 to 23 |
| | DP604 | 0.2 to 0.3 | GPa | 48.7 to 66 | MPa | 32.4 to 39.2 | MPa | −53 |
| | Betamate 73100 | 3.6 | GPa | 35.3 | MPa | 7.8 | MPa | 19.04 |
| | Betaseal X2500 | 18.5 | MPa | 4.2 | MPa | 3.02 | MPa | −56.3 |
| | Betalink K2 | 30.7 | MPa | 3.2 | MPa | 1.7 | MPa | −46.7 |
| Acrylic | LORD 850/Acc. | 1.5 | GPa | 0.7 | GPa | 5.4 | MPa | 71.7 |
| | 25GB | | | | | | | |
| Silane | Teroson MS | 15.7 | MPa | 4.8 | MPa | 4.6 | MPa | −59.6 |
| Modified | 9399 | | | | | | | |
| Polymers | Teroson MS | 9.8 | MPa | 2 | MPa | 1 | MPa | −62.2 |
| | 930 | | | | | | | |
| | VIASeal XB | 205-315 | MPa | 4.8-6.7 | MPa | 2-3 | MPa | −26.23 |
| Silicone | Dow Corning | 20.9 | MPa | 1.9 | MPa | 1.2 | MPa | −37 |
| | 7091 | | | | | | | |

The adhesive material may be applied in a variety of ways. For example, the adhesive is applied manually using an applicator gun and mixing nozzle or premixed syringes, or by using a robotic adhesive dispenser, and spread uniformly using any of the following, for example, a roller, a brush, a doctor blade or a draw down bar. In addition, the adhesive can be applied in a continuous fashion or in a segmented fashion.

In one example, the adhesive is applied to the decorated or non-decorated glass substrate prior to engaging the decorated or non-decorated glass substrate with the frame. In another example, the adhesive is applied to the frame prior to engaging the decorated or non-decorated glass substrate. In still other examples, the decorated or non-decorated glass and/or the frame can have surface coating or texturing, for example, such as using a primer system, etching, surface roughening or e-coating at a point before engaging the glass substrate and the frame. In yet another example, the decorated or non-decorated glass substrate can be cold formed to a curved frame by any suitable method, including at least one of vacuum forming.

The adhesive can be cured for a suitable period of time and under any suitable conditions, including at room temperature (e.g., 24° C.), at elevated temperatures (see Table 2 for examples) or with actinic radiation (e.g., IR or ultraviolet light). The curing of the adhesive either until handling strength is achieved or full cure can also be carried out in a vacuum chuck.

TABLE 2
Examples of curing conditions/
schedules for various adhesives

| | Adhesive |
|---|---|
| Toughened | 3M DP460 Epoxy |
| Epoxy | (cured at 24° C./48 hrs., or 49° C./3 hr. or |
| | 66° C./1 hr.) |
| | EP21TDCHT-LO |
| | (cured at 24° C./48-72 hrs. or 66° C./2-3 hr.) |
| Flexible Epoxy | Epoxy 2216 |
| | (cured at 49° C./6 hr. or 66° C for 2 hr.) |
| | EP21TDC-LO |
| | (cured at 66° C. for 4 hr.) |
| | DP125 |
| | (cured at 24° C./7 hrs., or 49° C./3 hr. or |
| | 66° C./1 hr.) |
| Polyurethane | DP640 |
| | (cured at 49° C./8 hr. or 66° C./5 hr.) |
| | DP604NS |
| | (cured at 24° C./24 hrs., or 49° C./1 hr. or |
| | 66° C./20 min.) |
| Acrylic | LORD 850/Acc. 24 GB/AP-134 |
| | (cured at 24° C./2 hr.) |
| | LORD 410/Acc. 19 GB/AP-134 |
| | (cured at 24° C./24 hr.) |
| Silicone | Dow Corning 7091 |
| | (cured at 24° C./48 hr.) |
| | Teroson MS 9399 |
| | (cured at 24° C./48 hr.) |
| Acrylic foam | 3M VHB tape 5952 |
| tape | (cured at 24° C./72 hr.) |
| | 3M VHB tape 4611 |
| | (cured at 24° C./72 hr.) |

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed can be resorted to by those of ordinary skill in the art, and that such modifications and variations are considered to be within the scope of embodiments of the present disclosure

### EXAMPLES

The following working examples are provided for the purpose of illustration only and should not to be construed as limiting in any way the remainder of the disclosure. Therefore, the examples should be construed to encompass any and all variations which become evident as a result of the teaching provided herein.

The instant disclosure relates to structural adhesives that have been selected based on their material property attributes, as shown in FIG. 6, to enable cold formed glass technology in which the cold formed thin glass is held in concave and/or convex bend to curved structural frame via a single or combination of multiple structural adhesives for automotive interior applications resulting in a cold formed laminate/product with higher reliability and improved safety to consumers.

In one example, the following steps were followed:

A structural adhesive is dispensed using an applicator kit and uniformly coated to form a 8 mil wet film using a draw down coater (or film applicator, roller, trowel or plastic knife) either on the inked (minimum 0.25″ bezel width) or non-display area of the cover glass (which may be surface modified with plasma treatment or corona discharge to improve adhesion), or alternatively, on the structural frame [e.g., grit blasted aluminium (Al₂O₃ grit, 18-50 mesh)] which has been cleaned thoroughly with isopropyl alcohol or acetone. The cover glass is then laminated on to convex and/or concave curved structural frame of various bend radii (R250 mm, R400 mm, and R600 mm) using either negative-positive molds and held together by clamps or vacuum bag lamination or vacuum chuck lamination process.

The laminated stack is then put in an oven or autoclave to crosslink the adhesive as per the adhesive manufacturer's recommended cure schedule. The optical stack lamination is optional, and if included, can be performed either prior to or in conjunction with or after the cold forming of the cover glass to the structural frame with structural adhesive.

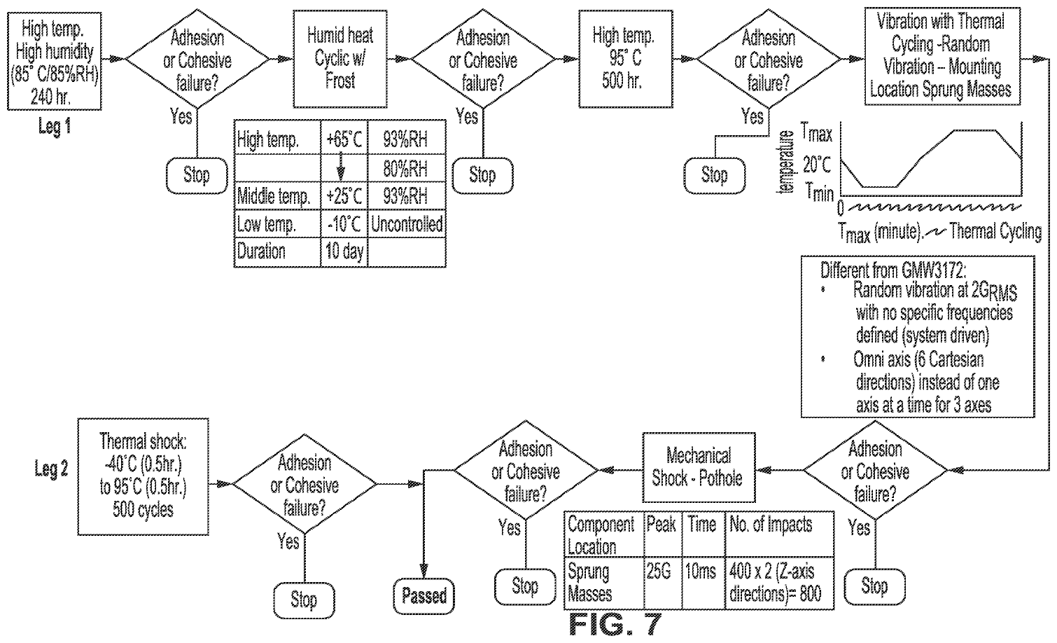

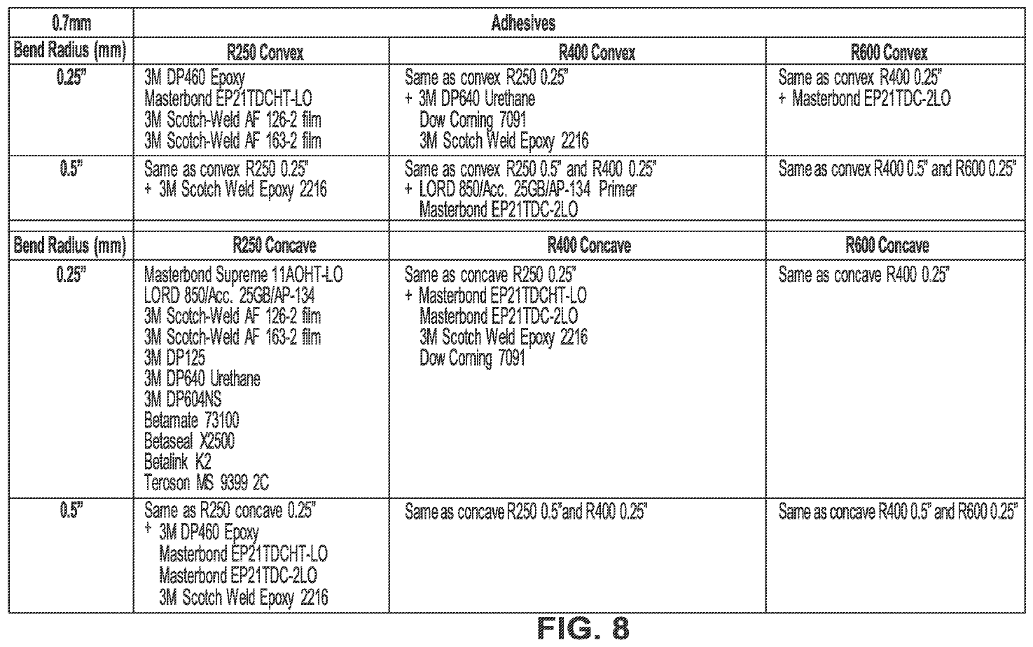

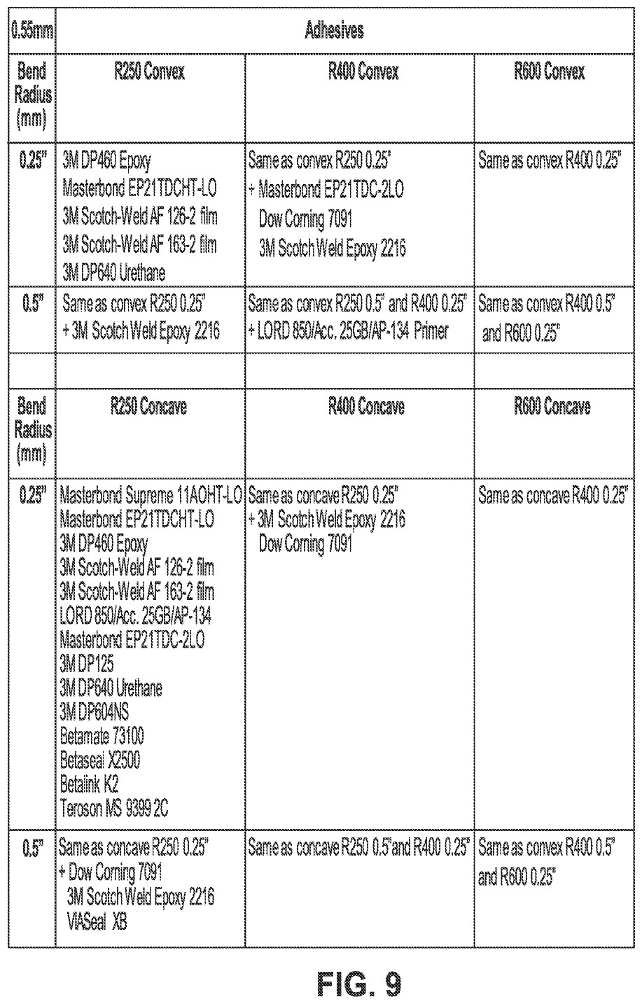

To prevent occurrence of any Mura-related issues in the display stack, the cure temperature of the structural adhesives is selected to be between 24-90° C. (e.g., 66° C.) for the thermally cured adhesives and room temperature or low temperature (e.g., <50° C.) for the Toughened Acrylics, Silane modified polymers and Silicone adhesives using the cure schedule recommended by the adhesive manufacturer. After the curing step, the laminate stack is then tested as per the industry accepted, albeit modified, accelerated Environmental/Durability Standard Tests (GMW3172) performed sequentially and/or in parallel (FIG. 7). This provides for optimal selection of structural adhesives for cold formed glass technology for different glass thicknesses and bonding bezel widths for various convex and/or concave bend radii for automotive interior applications. Various embodiments of adhesive and glass thicknesses combinations for specific shapes and bend radii are provided din FIGS. 8 and 9. This results in a product with higher design flexibility, higher reliability and improved safety to consumers, and opens up design space for interior automotive designers.

The present disclosure provides for the following embodiments, the numbering of which is not to be construed as designating levels of importance:

Embodiment 1 relates to a composite comprising: a cold-formed decorated or non-decorated glass substrate having first and second major surfaces; a metal or polymeric substrate having first and second major surface; and at least one adhesive located between the glass substrate first major surface and the metal or polymeric substrate first major surface; the glass substrate first and second major surfaces and the metal or polymeric substrate first and second major surfaces defining at least one curvature, the at least one curvature having a bend radius of about 60 mm or greater; wherein the composite maintains adhesion between the glass substrate and the metal or polymeric substrate following physical testing according to a modified GMW3172 environmental and durability test.

Embodiment 2 relates to the composite of Embodiment 1, wherein the at least one curvature has a bend radius of about 60 mm to about 5000 mm.

Embodiment 3 relates to the composite of Embodiments 1-2, wherein the glass substrate is formed of soda lime glass, aluminosilicate glass, borosilicate glass, boroaluminosilicate glass, alkali-containing aluminosilicate glass, alkali-containing borosilicate glass, alkali-containing boroaluminosilicate glass, polycarbonate, polyimide or acrylics.

Embodiment 4 relates to the composite of Embodiments 1-3, wherein the glass substrate has a thickness measured from the first major surface to the second major surface, at a glass's thickest portion, of about 0.2 mm to about 2 mm.

Embodiment 5 relates to the composite of Embodiments 1-3, wherein the glass substrate has a thickness measured from the first major surface to the second major surface, at a glass's thickest portion, of about 0.4 mm to about 1.1 mm.

Embodiment 6 relates to the composite of Embodiments 1-5, wherein the metal or polymeric substrate is formed of magnesium and alloys thereof; aluminum, and alloys thereof; steel, and alloys thereof; PC/ABS; PP/EPDM; PC/PBT; PP; and PC copolymer blends.

Embodiment 7 relates to the composite of Embodiment 5, wherein the metal substrate is formed of aluminum.

Embodiment 8 relates to the composite of Embodiment 1-5, wherein the polymeric substrate is at least one of filled and reinforced.

Embodiment 9 relates to the composite of Embodiments 1-8, wherein at least one of the glass substrate and the metal or polymeric substrate comprises a surface modification resulting from grit blasting or other surface roughening; galvanizing; e-coating; acid etching; priming; or painting.

Embodiment 10 relates to the composite of Embodiments 1-9, wherein the adhesive has a cohesive failure mode or the composite has adhesion failure at any given interface.

Embodiment 11 relates to the composite of Embodiments 1-10, wherein the adhesive comprises an epoxy, a polyurethane, an acrylate, a silane modified polymer or a silicone.

Embodiment 12 relates to the composite of Embodiments 1-11, wherein the adhesive has at least one of shrinkage upon cure of less than 5%; and low outgassing.

Embodiment 13 relates to the composite of Embodiments 1-12, wherein the adhesive has at least one of an overlap shear strength of at least 0.5 MPa; tensile strength of at least 0.5 MPa; % elongation at break of at least 3%; and a peel T-peel strength of at least 2 N/mm at a temperature of from about 22° C. to about 25° C.

Embodiment 14 relates to the composite of Embodiments 1-12, wherein the composite has at least one curve having a radius of curvature of about 250 mm or less; and the at least one adhesive has at least one of a Young's modulus of about 0.5 to about 5 GPa; tensile strength of about 15 MPa to about 80 MPa; % elongation at break of about 2% to about 20%; overlap shear strength of Al/Al of about 2 MPa to about 50 MPa; room temperature (RT) overlap shear strength of Al/polymeric substrate of about 2 MPa to about 40 MPa; and T-peel strength of about 2 N/mm to about 15 N/mm at a temperature of from about 22° C. to about 25° C.

Embodiment 15 relates to the composite of Embodiments 1-12, wherein the composite has at least one curve having a radius of curvature of about 250 mm or less; and the at least one adhesive has at least one of a glass transition temperature of from about 25° C. to about 100° C. and a storage modulus (E′) of from about 1 GPa to about 5 GPa at −40° C.; and from about 2 MPa to about 50 MPa at 95° C.

Embodiment 16 relates to the composite of Embodiments 14-15, wherein the at least one adhesive is a 2-part Toughened Epoxy.

Embodiment 17 relates to the composite of Embodiments 1-12, wherein the composite has at least one curve having a radius of curvature of about 150 mm to about 5000 mm; and the at least one adhesive has at least one of a Young's modulus of about 5 MPa to about 500 MPa; tensile strength of about 1 MPa to about 30 MPa; % elongation at break of about 10% to about 200%; overlap shear strength (Al/Al) of about 1 MPa to about 40 MPa; and T-peel strength of about 2 N/mm to about 10 N/mm.

Embodiment 18 relates to the composite of Embodiments 1-12, wherein the composite has at least one curve having a radius of curvature of about 150 mm to about 5000 mm; and the at least one adhesive has at least one of a glass transition temperature from about 10° C. to about 50° C.; and storage modulus (E′) of from about 0.25 GPa to about 5 GPa at −40° C. and from about 0.5 MPa to about 40 MPa at 95° C.

Embodiment 19 relates to the composite of Embodiments 17-18, wherein the at least one adhesive is a Flexible Epoxy.

Embodiment 20 relates to the composite of Embodiments 1-12, wherein the composite has at least one curve having a radius of curvature of about 150 mm to about 5000 mm; and the at least one adhesive has at least one of a Young's modulus of about 0.5 GPa to about 1 GPa; tensile strength of about 5 to about 35 MPa; % elongation at break of about 20% to about 150%; overlap shear strength (Al/Al) of about 5 MPa to about 30 MPa; and T-peel strength of about 2 N/mm to about 15 N/mm.

Embodiment 21 relates to the composite of Embodiments 1-12, wherein the composite has at least one curve having a radius of curvature of about 150 mm to about 5000 mm; and the at least one adhesive has at least one of a glass transition temperature from about 25° C. to about 100° C.; and storage modulus (E′) of from about 0.5 GPa to about 2 GPa at −40° C. and from about 0.5 MPa to about 40 MPa at 95° C.

Embodiment 22 relates to the composite of Embodiments 20-21, wherein the at least one adhesive is a Toughened Acrylic.

Embodiment 23 relates to the composite of Embodiments 1-12, wherein the composite has at least one curve having a radius of curvature of about 150 mm to about 5000 mm; and the at least one adhesive has at least one of a Young's modulus of about 1 MPa to about 925 MPa; tensile strength of about 1 to about 40 MPa; % elongation at break of about 40% to about 900%; overlap shear strength (Al/Al) of about 1 MPa to about 25 MPa.

Embodiment 24 relates to the composite of Embodiments 1-12, wherein the composite has at least one curve having a radius of curvature of about 150 mm to about 5000 mm; and the at least one adhesive has at least one of a glass transition temperature from about −70° C. to about 30° C.; and storage modulus (E′) of from about 10 MPa to about 5 GPa at −40° C. and from about 0.5 MPa to about 50 MPa at 95° C.

Embodiment 25 relates to the composite of Embodiments 23-24, wherein the at least one adhesive is a polyurethane.

Embodiment 26 relates to the composite of Embodiments 1-12, wherein the composite has at least one curve having a radius of curvature of about 150 mm to about 5000 mm; and the at least one adhesive has at least one of a tensile strength of about 1 MPa to about 10 MPa; % elongation at failure of about 50% to about 500%; overlap shear strength (Al/Al) of about 0.5 MPa to about 7 MPa.

Embodiment 27 relates to the composite of Embodiments 1-12, wherein the composite has at least one curve having a radius of curvature of about 150 mm to about 5000 mm; and the at least one adhesive has at least one of a glass transition temperature of from about −70° C. to about −5° C. and a storage modulus (E′) of from about 5 MPa to about 400 MPa at −40° C.; and from about 0.5 MPa to about 5 MPa at 95° C.

Embodiment 28 relates to the composite of Embodiments 26-27, wherein the at least one adhesive is a silane modified polymer.

Embodiment 29 relates to the composite of Embodiments 1-12, wherein the composite has at least one curve having a radius of curvature of about 400 mm to about 5000 mm; and the at least one adhesive has at least one of a tensile strength of about 0.5 MPa to about 5 MPa; % elongation at break of about 600% to about 1000%; overlap shear strength (Al/Al) of about 0.5 MPa to about 5 MPa.

Embodiment 30 relates to the composite of Embodiments 1-12, wherein the composite has at least one curve having a radius of curvature of about 400 mm to about 5000 mm; and the at least one adhesive has at least one of a glass transition temperature of from about −50° C. to about −10° C. and a storage modulus (E′) of from about 10 MPa to about 50 MPa at −40° C.; and from about 0.25 MPa to about 5 MPa at 95° C.

Embodiment 31 relates to the composite of Embodiments 29-30, wherein the at least one adhesive is a silicone or a siloxane.

Embodiment 32 relates to the composite of Embodiments 1-31, wherein the adhesive has a bezel width of about 2 mm to about 50 mm.

Embodiment 33 relates to the composite of Embodiments 1-32, wherein the composite has at least one curvature.

Embodiment 34 relates to the composite of Embodiment 33, wherein the at least one curvature is convex.

Embodiment 35 relates to the composite of Embodiment 33, wherein one of the at least one curvatures is a convex curvature and the second curvature is a concave curvature.

1. A composite comprising:
a cold-formed decorated or non-decorated glass substrate having first and second major surfaces;
a metal or polymeric substrate having first and second major surface; and
at least one adhesive located between the glass substrate first major surface and the metal or polymeric substrate first major surface;
the glass substrate first and second major surfaces and the metal or polymeric substrate first and second major surfaces defining at least one curvature, the at least one curvature having a bend radius of about 60 mm or greater;
wherein the composite maintains adhesion between the glass substrate and the metal or polymeric substrate following physical testing according to a modified GMW3172 environmental and durability test.

2. The composite of claim 1, wherein the at least one curvature has a bend radius of about 60 mm to about 5000 mm.

3. The composite of claim 1, wherein the glass substrate is formed of soda lime glass, aluminosilicate glass, borosilicate glass, boroaluminosilicate glass, alkali-containing aluminosilicate glass, alkali-containing borosilicate glass, alkali-containing boroaluminosilicate glass, polycarbonate, polyimide or acrylics.

4. The composite of claim 1, wherein the glass substrate has a thickness measured from the first major surface to the second major surface, at a glass's thickest portion, of about 0.2 mm to about 2 mm.

5. (canceled)

6. The composite of claim 1,
wherein the metal or polymeric substrate is formed of magnesium and alloys thereof;
aluminum, and alloys thereof; steel, and alloys thereof; PC/ABS; PP/EPDM; PC/PBT;
PP; and PC copolymer blends.

7. The composite of claim 6, wherein the metal substrate is formed of aluminum.

8. The composite of claim 1, wherein the polymeric substrate is at least one of filled and reinforced.

9. The composite of claim 1, wherein at least one of the glass substrate and the metal or polymeric substrate comprises a surface modification resulting from grit blasting or other surface roughening; galvanizing; e-coating; acid etching; priming; or painting.

10. The composite of claim 1, wherein the adhesive has a cohesive failure mode or the composite has adhesion failure at any given interface.

11. The composite of claim 1, wherein the adhesive comprises an epoxy, a polyurethane, an acrylate, a silane modified polymer or a silicone.

12. The composite of claim 1, wherein the adhesive has at least one of shrinkage upon cure of less than 5%; and low outgassing.

13. The composite of claim 1, wherein the adhesive has at least one of an overlap shear strength of at least 0.5 MPa; tensile strength of at least 0.5 MPa; % elongation at break of at least 3%; and a peel T-peel strength of at least 2 N/mm at a temperature of from about 22° C. to about 25° C.

14. (canceled)

15. (canceled)

16. (canceled)

17. The composite of claim 1, wherein the composite has at least one curve having a radius of curvature of about 150 mm to about 5000 mm; and the at least one adhesive has at least one of a Young's modulus of about 5 MPa to about 500 MPa; tensile strength of about 1 MPa to about 30 MPa; % elongation at break of about 10% to about 200%; overlap shear strength (Al/Al) of about 1 MPa to about 40 MPa; and T-peel strength of about 2 N/mm to about 10 N/mm.

18. The composite of claim 1, wherein the composite has at least one curve having a radius of curvature of about 150 mm to about 5000 mm; and the at least one adhesive has at least one of a glass transition temperature from about 10° C. to about 50° C.; and storage modulus (E′) of from about 0.25 GPa to about 5 GPa at −40° C. and from about 0.5 MPa to about 40 MPa at 95° C.

19. (canceled)

20. The composite of claim 1, wherein the composite has at least one curve having a radius of curvature of about 150 mm to about 5000 mm; and the at least one adhesive has at least one of a Young's modulus of about 0.5 GPa to about 1 GPa; tensile strength of about 5 to about 35 MPa; % elongation at break of about 20% to about 150%; overlap shear strength (Al/Al) of about 5 MPa to about 30 MPa; and T-peel strength of about 2 N/mm to about 15 N/mm.

21. The composite of claim 1, wherein the composite has at least one curve having a radius of curvature of about 150 mm to about 5000 mm; and the at least one adhesive has at least one of a glass transition temperature from about 25° C. to about 100° C.; and storage modulus (E′) of from about 0.5 GPa to about 2 GPa at −40° C. and from about 0.5 MPa to about 40 MPa at 95° C.

22. (canceled)

23. The composite of claim 1, wherein the composite has at least one curve having a radius of curvature of about 150 mm to about 5000 mm; and the at least one adhesive has at least one of a Young's modulus of about 1 MPa to about 925 MPa; tensile strength of about 1 to about 40 MPa; % elongation at break of about 40% to about 900%; overlap shear strength (Al/Al) of about 1 MPa to about 25 MPa.

24. The composite of claim 1, wherein the composite has at least one curve having a radius of curvature of about 150 mm to about 5000 mm; and the at least one adhesive has at least one of a glass transition temperature from about −70° C. to about 30° C.; and storage modulus (E′) of from about 10 MPa to about 5 GPa at −40° C. and from about 0.5 MPa to about 50 MPa at 95° C.

25. (canceled)

26. (canceled)

27. (canceled)

28. (canceled)

29. (canceled)

30. (canceled)

31. (canceled)

32. The composite of claim 1, wherein the adhesive has a bezel width of about 2 mm to about 50 mm.

33. The composite of claim 1, wherein the composite has at least one curvature.

34. (canceled)

35. (canceled)
